(19) United States
(12) Patent Application Publication
(10) Pub. No.: US 2023/0203607 A1
(43) Pub. Date: Jun. 29, 2023

(54) Biomass Direct Reduced Iron

(71) Applicant: Technological Resources Pty. Limited, Melbourne (AU)

(72) Inventor: Michael Buckley, Mosman Park (AU)

(21) Appl. No.: 17/926,981

(22) PCT Filed: May 25, 2021
(86) PCT No.: PCT/AU2021/050494

§ 371 Date: Nov. 21, 2022

(30) Foreign Application Priority Data
May 25, 2020 (AU) 2020901681

(51) Int. Cl. C21B 13/00

(52) U.S. Cl. CPC C21B 13/004; C21B 13/008

(57) ABSTRACT

A compacted ‘green’ briquette between 5 cm³ and 20 cm³ including, prior to reduction in a direct reduction process, a composition including at least 30% lignocellulosic biomass material by dry weight and at least 55% iron ore fines by weight, a density of between 1.4 g/cm³ and 2.0 g/cm³, and a compaction strength of at least 500N. A direct reduced iron briquette suitable for the production of iron and/or steel including at least 85% iron by weight and at least 1% fixed carbon by weight, and a volume of between 7.5 cm³ and 30 cm³, wherein the briquette has, prior to reduction (i.e. as a ‘green’ briquette), the above composition.

### TECHNICAL FIELD

The present invention relates to the production of iron.

The present invention relates particularly, although by no means exclusively, to a new composition of ‘green’ briquette comprising iron ore fines and raw biomass having sufficient compressive strength that is suitable for subsequent conversion into direct reduced iron (DRI) within a reduction furnace.

The present invention relates particularly, although by no means exclusively, to a compacted ‘green’ briquette comprising iron ore fines and raw biomass for producing DRI within a furnace wherein the resultant DRI therefrom has at least 85% metallic iron by weight and at least 1% fixed carbon.

The present invention relates particularly, although by no means exclusively, to DRI made from the above-described ‘green’ briquette. Such DRI, for example while hot, may be subsequently melted in a furnace to create hot metal, then cast as pig iron or refined further to steel in a metallurgical furnace. Alternatively, by way of further example, the hot DRI may be compressed between a pair of rollers with aligning pockets to form a hot briquetted iron (HBI), which can subsequently be supplied to a furnace as a cold charge.

The term “direct reduced iron (“DRI”)” is understood herein to mean iron produced from the direct reduction of iron ore (in the form of briquettes, lumps, pellets, or fines) to iron by a reducing gas at temperatures below the bulk melting temperature of the solids.

### BACKGROUND

Iron and steel making are historically carbon intensive processes in which the majority of the carbon used is eventually oxidised to CO₂ and discharged to the atmosphere. With the world seeking to reduce overall atmospheric CO₂ there is pressure on iron and steel makers to find means to make iron and steel without causing net emissions of greenhouse gases. In particular there is pressure to not use coal and natural gas, which are considered non-renewable.

The majority of iron in the world is produced by the blast furnace route, which is a technology that has existed since prior to the industrial revolution. Even with technology advances the blast furnace currently still requires around 800 kg of metallurgical coal for every tonne of iron produced and emits high levels of CO₂, roughly 1.8-2.0 t CO₂ per tonne of hot metal. The use of fossil fuels, in particular the requirement for coal (in the form of coke), is an essential feed material for a blast furnace to operate, and it is not possible to simply use hydrogen as a complete substitute.

An alternative approach to blast furnaces is the direct reduction of iron ore in the solid state by carbon monoxide and hydrogen derived from natural gas or coal. While such plants are (outside of India) minor in number compared to blast furnaces there are many processes for the direct reduction of iron ore. In India, coal based rotary kiln furnaces are used to produce DRI, also known as sponge iron (approaching 20% of world production of DRI), while elsewhere gas-based shaft furnace processes tend to be used (approaching 80% of world production of DRI). The gas-based direct reduction plants are usually part of integrated steel mini-mills, located adjacent to electric arc furnace (EAF) steel plants, but some DRI is shipped from captive direct reduction plants (usually Midrex™ or HYL™ process-based plants) to remote steel mills.

Because DRI is typically used in electric arc furnaces, there are strict requirements on the levels of impurities in the DRI such as gangue and phosphorus which are expensive and difficult to remove in the EAF, and can significantly reduce productivity.

Hence, the iron ores used to make DRI are often crushed and ground to micron particle sizes to enable removal of gangue minerals. Such fine material is difficult to handle (both transport and operationally wise) so it is then agglomerated using water and/or binder to produce closely sized ‘green’ balls which are, once dried, then fed into furnaces where the ‘green’ balls are fired into hard pellets (a process known as induration), before eventually being supplied to direct reduction plants as feed material (or sometimes to blast furnaces as a high quality iron ore feed material to help dilute the gangue of the lump or sinter iron ore that a blast furnace uses). The ‘green’ balls that form the pellets have a typical compressive strength of around 10 N when wet, and 50 N when dried. As pellets (after induration) they have a compressive strength of around 2000 N.

In integrated mini-mills, natural gas based DRI can be hot charged into the EAF at temperatures in the region of 650° C., thus making some energy savings in power and the amount of fossil fuels used, but the total lifecycle CO₂ emitted still remains high at around half blast furnace levels due to the fact that natural gas is a lower carbon intensity fuel than coal.

While it would be possible to use ‘green’ hydrogen as a substitute fuel in direct reduction plants, presently green hydrogen remains cost prohibitive (and not readily transportable in the amounts required).

It is known that sustainable biomass could be a complementary part of the solution, acting as a substitute for fossil fuels, without causing net emissions of greenhouse gases. Burning either fossil fuels or biomass releases CO₂ when used, however when fast growing or regrown plants are the source of the biomass, they are largely a carbon-neutral energy source, as through photosynthesis almost the same amount of CO₂ is taken up when the plants are regrown.

To date, there is no large-scale commercial iron making process that uses biomass directly.

Previous attempts to insert some biomass into processes originally designed for coal (e.g. blast furnaces and coke ovens) are marginal at best and usually quite disappointing in terms of overall CO₂ impact. This is largely because the nature of biomass is vastly different to that of coal. To use biomass successfully it is necessary to re-design the process around the fundamental nature of biomass.

There have been approaches at the laboratory phase (see AU 2007227635 B2 in the name of Michigan Technological University) where briquettes (in the shape of coherent spherical balls) have been produced by mixing iron ore concentrate comprising magnetite (Fe₃O₄) and wood chips that have passed through a 4.75 mm sieve, mixed with a small amount of flour and slight moistening (to achieve agglomeration). Such composites have been dried at 105° C. (to provide strength and rigidity) in handling. They have then been placed in a furnace (that has been electrically heated) at temperatures in excess of 1375° C. to undertake the reduction of the iron ore. AU 2007227635 B2 notes that preferably fine iron ore particles should be used and that while ‘particles as large as 0.25 inch in diameter’ (i.e. the typical top size of iron ore fines, being 6.35 mm) ‘or larger could be used, processing times would be unnecessarily long and particles would not lend themselves to being formed into a coherent mass’. AU 2007227635 B2 also states that it is preferable that small particles be used that are finely ground, where finely ground ‘meant particles 90% of which will at least pass a 75 micrometre screen’.

As noted, the use of such ‘green’ briquettes when using iron ore fines to produce DRI on a commercial scale would be challenging from the point of view of achieving consistency of iron ore to biomass ratios. Such briquettes also require a drying phase to ensure the briquettes have sufficient strength to address the rough and tumble of downstream handling (i.e. storage and eventual transportation into the furnace of choice). While iron ore concentrates typically have higher concentrations of iron oxides, significant amounts of energy are used to grind them down to micrometre sizes (where they can be separated from gangue contaminates like silica found in the host ore body).

Biomass, such as wood chips, has also been shown to be able to reduce iron ore to solid iron by the intermingling thereof with iron ore and placing in a furnace that heats the ore up to over 800° C. within a controlled atmosphere that prevents re-oxidation of the reduced material. While intermingling assists with the efficacy of the reduction process, on an industrial scale it potentially leads (except where hydrogen is used as the reductant) to large amounts of char that need to be separated from the produced DRI. This can be further compounded where gas flow created as part of the reduction process picks up fine particles of char, leading to massive gas processing/char recycling challenges, or a lot of carbon being wasted through the need to clean up the off-gases of the process, before discharge to the atmosphere.

There are many possible alternative approaches to production of DRI. One of these approaches (currently being developed by the applicant and described in the applicant's International patent PCT/AU2017/051163, the disclosure of which is incorporated herein by cross-reference), involves briquetting ore and biomass, then using a furnace, for example like a linear or rotary heath furnace (or a rotary kiln), to preheat the material to around 400-900° C., thereby also devolatilising the biomass and removing any bound water from the ore. Ore pre-reduction is expected to reach around 40-70% under such conditions. This is followed by a microwave treatment stage (in a non-oxidising atmosphere) where the briquettes are heated to around 1000-1100° C. and reduced (using residual bio-carbon) further, with reductions typically around 90-98% and in some instances up to almost full metallisation. This DRI may then be fed to an open-arc furnace, an induction furnace or some other form of melting vessel to produce pig iron.

The above description is not to be taken as an admission of the common general knowledge in Australia or elsewhere.

### SUMMARY OF THE INVENTION

The present invention is an alternative approach to the production of DRI using biomass as a feed material for the direct reduction process.

Ideally, it would be advantageous to have briquettes as the feed material for direct reduction in which, the iron ore within them is in the millimetre size range (usually referred to as iron ore fines), the materials can be mixed readily and there is no need to add a formal binder or add water in a bid to form a dough (as part of the mixing process), nor use a drying step after (to dry the dough material out) to achieve briquette strength.

The inventor has found that a briquette formed by mixing selected forms of biomass with iron ore fines and forming, for example by pressing, them into a ‘green’ briquette to above a particular density, can produce a ‘green’ briquette that can withstand the rigors of handling (as a briquette), i.e. the rough and tumble of being mechanically handled for transportation and processing purposes.

In some instances, prior art briquettes of certain biomass types require specific material to act as a binder to form a briquette that would gain enough strength to maintain integrity during such handling. The inventor has found that such binders, when used with the selected forms of biomass of the invention, were unnecessary (and if used gave minimal improvement to compressive strength). It is noted nevertheless that the invention does not exclude the use of binders and or fluxes.

In the context of the preceding paragraph, the invention is based on a surprising realisation that iron ore fines and lignocellulosic biomass material, such as lignocellulosic waste biomass material, can be mixed together without the addition of other materials that act as a binder and formed into a compacted briquette that has a mechanical strength that can cope with materials handling within a briquette manufacturing plant and transportation to and processing in direct reduction processes, as described above.

Lignocellulosic waste biomass material, such as wheat straw, rice straw and corn stover (Kim and Dale, Biomass and Bioenergy, 26(4) 361-375, April 2004), and bagasse, are some of the most abundant waste biomass material among agricultural residues in the world. As an example, wheat straw consists mainly of cellulose (28-39%), hemicelluloses (23-24%), lignin (16-25%), along with some ash and protein (Carvalheiro et al., Applied Biochemistry and Biotechnology, 153(1-3) 84-93, May 2009).

The inventor has found, surprisingly, that when such lignocellulosic waste biomass material is mixed with iron ore fines (without any use of binders or added water as used to make iron ore pellets), the resultant mixture is not only suitable for forming briquettes of the required strength for handling, transportation, etc., but have held together during a DRI reduction process to produce DRI with at least 85% iron and 1% fixed carbon by weight. This is not only surprising from a binding perspective i.e. the ‘green’ briquette, but is also surprising from an iron reduction recovery perspective and the amount of fixed carbon within the briquette that is obtained.

It is speculated that reductions of greater than 85% are achieved (all other things being equal) because of the compaction of the briquette into a dense state that leads to the lignocellulosic biomass material mechanically interacting with the iron ore fines, such as by being wrapped intimately around all the iron ore fines, such that grinding down the ore particles to micro millimetres is unnecessary to get good reduction of the ore.

The invention is a compact ‘green’ briquette that can be used as a feed material for the process described in the above-mentioned International patent application PCT/AU2017/051163. The compact ‘green’ briquette of the invention can also be used as a feed material for other iron making processes and in its DRI form can be used as a feed material for downstream steelmaking processes (subject to gangue control limitations for the different processes).

The above described processes for producing DRI are described collectively herein as ‘direct reduction processes’. Hot DRI produced in such ‘direct reduction processes’ that itself has been compressed between a pair of rollers with aligning pockets is described collectively herein as hot briquetted iron (HBI).

The invention is a compacted ‘green’ briquette that is suitable for a direct reduction process, the briquette being between 5 cm³ and 20 cm³ (in matrix size) including, prior to reduction in a direct reduction process, a composition including at least 30% lignocellulosic biomass material, such as lignocellulosic waste biomass material, by dry weight and at least 55% iron ore fines by weight, a density of between 1.4 g/cm³ and 2.0 g/cm³, and a compaction strength of at least 500 N.

The term “dry weight” is understood herein to mean the weight of the biomass following its drying by a standard technique. There are a number of standards for biomass, typically revolving around heating the biomass to 105° C. and measuring the before drying and after drying weights. One such standard is ISO 18134-3:2015. Sometimes, “dry weight” is referred to as “oven dried tonnes” (odt) for woody biomass.

There is a number of industry standards for measuring compaction strength.

The term ‘iron ore fines’ is understood herein to mean iron ore sized between 0.15 mm (150 micrometres) and 3 mm, with no more than 25% by weight being micro-fines (below 0.15 mm) contained therein. Preferably, the amount of fines above 3 mm is no more that 5% by weight. Preferably there are no fines above 6.35 mm so as to avoid excess wear on briquette pressing equipment and/or significant numbers of briquettes that do not have the required compaction strength because of size interference between the presses/rolls.

The term ‘biomass’ is understood herein to mean living or recently living organic matter in its raw form, i.e. material is in an uncarburised state.

The term ‘lignocellulosic’ is understood herein to mean any of several closely-related substances consisting essentially of cellulose and hemicellulose in a lignin framework. Such lignocellulosic biomass can be found within forestry products and by-products (including mill residues), agricultural products and by-products (including residues such as straw and chaff waste from harvesting crops) and/or energy crops such as sorghum, switchgrass and sugar cane (as sugar cane bagasse) including short rotation coppice crops including willow and poplar.

A preference for the lignocellulosic biomass material is that its overall length be less than around 6 mm in the form supplied for briquetting in accordance with embodiments of the invention, noting that this preference may involve segmenting longer lengths of material into much smaller lengths.

There is no requirement to dry the lignocellulosic biomass material, beyond any natural drying that occurs, although the invention does not exclude the use of dryers, etc.

The term ‘briquette’ is understood herein to mean a product that is greater 5 cm³ and is of a general cuboid shape with rounded edges/corners (typically described as ‘pillow’ shaped). Such briquettes are typically formed by a pressing/compressive action, although extrusion, with segmenting (into discrete briquette sized sections), is a potential alternative approach.

To be clear, pellets that are a spherical shape and created by the balling of material through agglomeration are not briquettes according to the invention. Typically, a briquette is defined by its ‘matrix size’ which is the nominal volume of the briquette formed by filling the cavity within the moulds/rolls when they come completely together. A typical cavity for a briquette of 5 cm³ matrix size has the dimensions 30 mm long by 24 mm wide by 17 mm high (at their maximum lengths) with rounded edges/corners. For a 10 cm³ matrix size of similar shape, the dimensions are 33 mm long by 30 mm wide by 20 mm high. For a 20 cm³ matrix size of similar shape, the dimensions are 46 mm long by 34 mm wide by 25 mm high. In the case of ‘compacted’ briquettes, their actual volume will be larger than the matrix size as the mould/rolls do not in practice come together due to an excess of material being fed to ensure complete compaction within the void, i.e. the matching moulds/rolls creating the cavities for forming the briquettes are held apart from each other by such excess material. There is also usually expected to be some natural spring back of the compacted material upon release from the moulds/rolls.

The invention is also a direct reduced iron briquette that is suitable for the production of iron and/or steel in a downstream ironmaking/steelmaking process, the briquette being formed by reducing the above-described compact ‘green’ briquette in a direct reduction process, including at least 85% iron by weight and at least 1% fixed carbon by weight, and having a volume of between 7.5 cm³ and 30 cm³, wherein the briquette has prior to reduction has a composition including at least 30% lignocellulosic biomass material, such as lignocellulosic waste biomass material, by dry weight and at least 55% iron ore fines by weight.

The term “fixed carbon” is understood herein to mean the solid combustible residue that is left after a briquette is heated and volatiles are removed. There is a number of industry standards for measuring “fixed carbon”. It is noted that actual fixed carbon amounts realised during processing vs the number obtained by lab testing can depend on a range of issues such as heating rate. ISO 18123:2015 is a relevant standard.

The composition of the compacted ‘green’ briquette may include non-volatile carbon material that is not lignocellulosic biomass material.

The non-volatile carbon material may be no more than 5% by weight of the composition of the compacted ‘green’ briquette.

The non-volatile carbon material may be selected so that the fixed carbon of the briquette after the direct reduction process is at least 3% carbon by weight.

The amount of the non-volatile carbon material may be selected so that the fixed carbon of the briquette after the direct reduction process is at least 4% carbon by weight.

The composition may include at least 1% by dry weight of a flux material, such as limestone.

The compacted briquette may have a “green”, i.e. as formed, compaction strength of at least 650 N, typically at least 750 N, and more typically at least 850 N.

The compacted briquette may have a substantial amount of iron ore fines within the briquette that are between 0.15 mm and 2.0 mm in size.

The meaning of the term “substantial” is difficult to quantify but will be understood by the skilled person. It is difficult to quantify because there are multiple options for obtaining ore, such as goethitic ore, for the invention with different distributions of sizes, e.g.: screening out the −2 or −3 mm fractions of sinter fines, crushing sinter fines to −3/−2 mm, and using tailings of sufficient quality. Each of option will produce different amounts of process sable fines.

The lignocellulosic biomass material may be selected on the basis of its capacity to bend (i.e. fold, flex or plastically deform) around iron ore fines during compaction to form the briquette.

Typically, the lignocellulosic biomass material is in the form of elongate elements that plastically deform during compaction and wrap around iron ore fines and thereby ensure close contact of biomass material and iron ore fines.

Surprisingly, the inventor has found that the use of fines (as against the use of all micro fines) aids in such plastic deformation and lead to the interlocking of the material in the compacted briquette.

The lignocellulosic biomass material may form a majority of the surface area of the compacted briquette.

The lignocellulosic biomass material may form a majority of the volume of the compacted briquette.

Typically, the lignocellulosic biomass material is >55% of the volume of a green briquette.

In any given situation, the amount of the lignocellulosic biomass material is a function of a number of factors including biomass type, processing ratios, etc.

The lignocellulosic biomass material may include tubular stalks of grasses.

The lignocellulosic biomass material may include wood saw dust.

The non-volatile carbon material may include coal.

The non-volatile carbon material may include char, coke or carbon containing soot.

The fixed carbon may be derived from the lignocellulosic biomass material.

The fixed carbon may come from other carbonaceous sources such as coal.

The invention is also a method of manufacturing the above-described compacted ‘green’ briquette including mixing together a lignocellulosic biomass material and iron ore fines and compacting the mixture into the briquette.

The method may be carried out in any suitable briquette forming apparatus.

The invention also provides a direct reduction process that includes reducing the above-described compacted briquette in a furnace and producing iron.

### BRIEF DESCRIPTION OF THE PHOTOGRAPH AND DRAWING

The present invention is described further by way of example with reference to the accompanying photograph and drawings, of which:

FIG. 1 is a photograph of one embodiment of a briquette for producing direct reduced iron (DRI) from iron ore and lignocellulosic biomass material in accordance with the invention; and

FIG. 2 is a flowsheet diagram illustrating an embodiment of a process and an apparatus for producing ‘green’ briquettes from iron ore and lignocellulosic biomass material in accordance with the invention for subsequent reduction to produce direct reduced iron (DRI).

### DESCRIPTION OF EMBODIMENT OF BRIQUETTES ACCORDING TO THE INVENTION

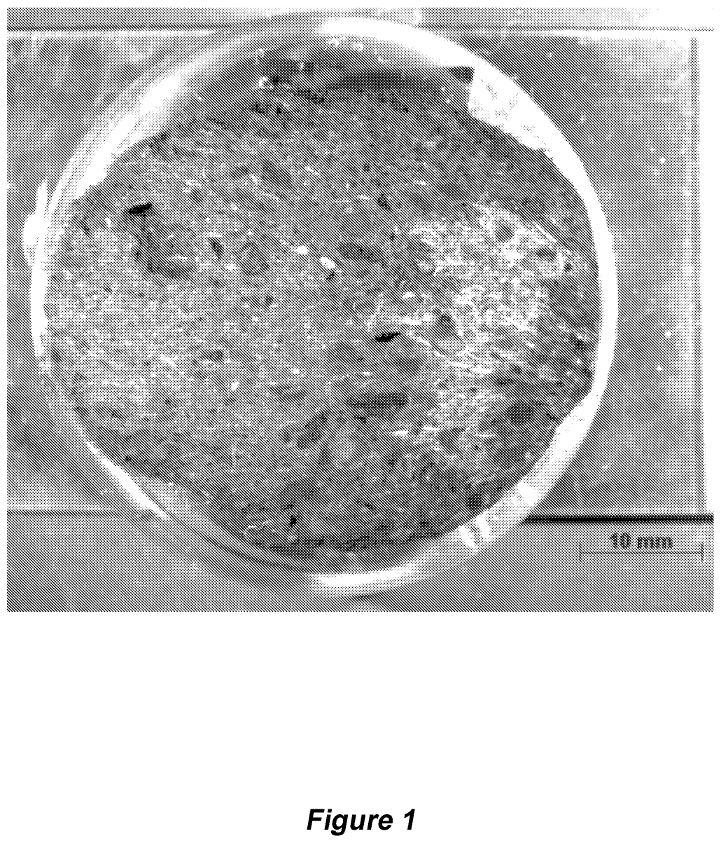

FIG. 1 is a photograph of a section of one embodiment of a briquette in accordance with the invention.

The briquette shown in FIG. 1 consists of lignocellulosic biomass material and iron ore fines, with no binders.

The briquette was formed by mixing sized sugar cane bagasse and iron ore of the desired ratio in an Eirich horizontal intensive mixer, and then passing it through a Maschinenfabrik Köppern GmbH & Co. KG industrial-sized briquetting machine at the University of Freiberg in Germany.

It is noted that the invention is not confined to briquettes that only include lignocellulosic biomass material and iron ore fines. The invention extends to briquettes that include other materials, such as binders.

It is evident from FIG. 1 that the lignocellulosic biomass material (in this case bagasse of particle length 1 to 2 mm) has deformed in a plastic manner around the iron ore fines (<2 mm) to encase the ore fines intimately as well as form the majority of the surface area of the ‘green briquette’.

The inventor has found that the use of such lignocellulosic biomass material, such as tubular stalks of grasses, appears to trap the smaller fines (<1 mm) in the briquette ‘structure’ without leaving them exposed to the outer surface of the briquette, thus minimising dust make, while in a DRI reduction process allowing volatiles (generated during the heating phase between 100°−600° C. in producing a DRI briquette) a pathway to move through and escape the briquette, without undue breakdown of the briquette.

When ‘green’ briquettes according to the invention are reduced to DRI by way of example using the method described in the applicant's earlier International patent application PCT/AU2017/051163, they not only retain a good degree of compressive strength (particularly when cooled naturally) but have at least 85% iron and at least 1.0% fixed carbon by weight.

Having fixed carbon in reduced briquettes, as against having all the carbon consumed in the reduction process, can be desirable for downstream ironmaking or steelmaking process, where the briquette is required to be melted as part of the relevant process.

By way of example only, the Basic Oxygen Furnace (BOF) relies on carbon within molten iron to reconvert FeO formed by driving oxygen into the bath (effectively burning iron) to bring the temperature up to the melting point of steel, which can be above 1400° C. Having a DRI (in the form of HBI) with a fixed carbon above 2% potentially lowers the melting point of such feed material to around 1400° C., as against say pure iron with a melting point of 1538° C. Bringing the fixed carbon up to 4% lowers the melting point further to around 1200° C. While a BOF relies on its principal charge already being molten iron, it is supplemented (typically, up to 20% of the charge) by scrap steel, solid pig iron or DRI. Anything that reduces the energy needed to melt the supplemental material improves the efficiency of the process and effectively reduces the amount of FeO (arising from the fast combustion/melting process) that has to be reduced back to iron by reacting with dissolved carbon or that by default passes out of the process into the slag.

The production of HBI from hot DRI produced by a direct reduction processes is known within the iron industry and briquetting machines therefor are available throughout the world, such as from Maschinenfabrik Köppern GmbH & Co. KG in Germany.

### Embodiment of Method of Manufacture of Embodiment Briqettes According to the Invention

As noted above, in broad terms, the present invention is based on forming a compacted ‘green’ briquette of between 5 cm³ and 20 cm³ (in matrix size) that has, prior to reduction in a direct reduction process, a composition of at least 30% lignocellulosic biomass material by dry weight and at least 55% iron ore fines by weight and a strength of at least 500 N.

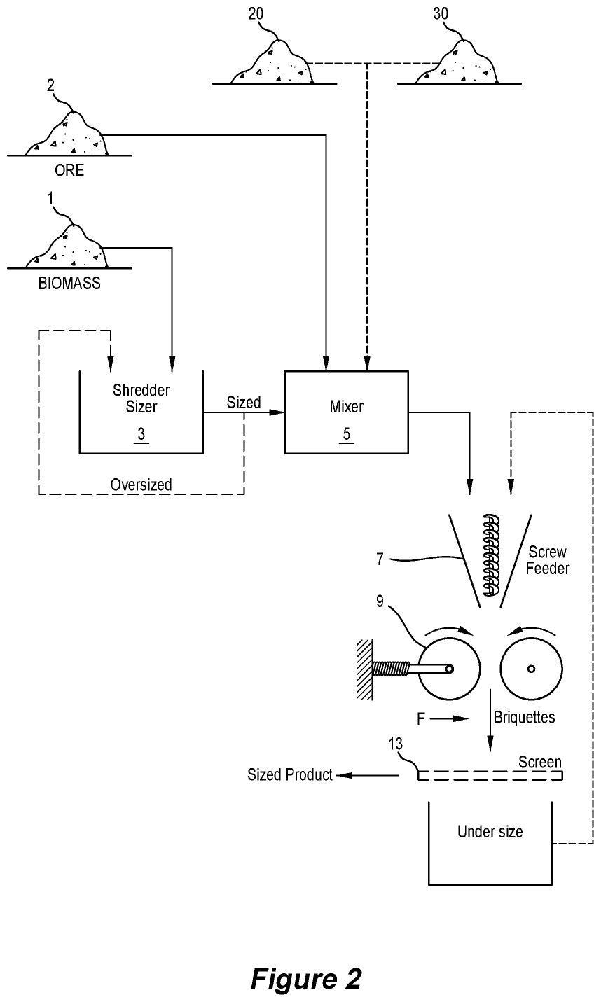

FIG. 2 is a flowsheet diagram illustrating an embodiment of a process and an apparatus for producing ‘green’ briquettes from iron ore and lignocellulosic biomass material in accordance with the invention.

In FIG. 2, the apparatus includes a shredder/sizer 3 for reducing the size of a lignocellulosic biomass feed material 1, which may be any suitable lignocellulosic biomass, down to a preferred size below 6 mm.

The shredder/sizer 3 may take many forms, but for manufacturing the sample briquettes according to the invention for the Example, an industrial pin disk mill (exp. cap. 2 t/h) was used, with the material discharged through a perforated plate of either −4 mm or −1 mm and oversize material returned for further processing through the mill. All material processed through the mill was dry (as shipped).

While not shown in FIG. 2, the lignocellulosic biomass material may be pre-cut to a set size, such as 6 mm, for feeding into the shredder/sizer 3.

Once the lignocellulosic biomass material is sized, it is mixed in a mixer 5 thoroughly with iron ore fines 2 and other minor additives such as flux 20 and fixed carbon 30.

The mixer 5 may take many forms, but for the briquettes produced in test work of the inventor, an Eirich, 175 litre horizontal intensive mixer was used in batch mode with 90 seconds mixing time.

An important mixing requirement for the embodiment is that there be good mixing behaviour so that a homogenous mix is achieved with no segregation between ore and biomass. The mixing however is not for the purpose of agglomeration i.e. having the iron ore fines and lignocellulosic biomass form a dough that itself becomes a coherent mixture. The ratio of material fed to the mixer by weight is at least 55% iron ore fines and at least 30% lignocellulosic biomass material by weight (naturally dried). The balance of the mixture (other than those materials) in the case of the examples referenced in Table 1 in the Example is taken up by limestone or slaked lime (around 10 percent), which is a flux for the downstream reduction and/or smelting/melting processes i.e. to seek a basicity of about 1.2 (CaO/SiO₂). Up to 5% primarily non-volatile carbon material (fixed carbon 30); like coke may also be added to the mix.

After appropriate mixing, the mixed material is fed into a screw feeder 7, which sits atop of a pair of counter-rotating briquetting rolls 9 which have suitable size and shape pockets machined/etched into the faces (not shown). In operation, the rolls are rotated in a synchronized manner such that the pockets align in a nip between the rolls. Typically, one roll may be fixed and the other roll floating and have a set force applied to it so that a relatively constant pressure is applied to the rolls and the material passing through the nip. The required pressure may be set as required, but generally the nip between the rolls should be minimised, while still allowing iron fine particles to pass between the rolls (in the non-pocketed spaces) without undue crushing/grinding occurring, i.e. the purpose of the rolls is not to crush or grind the iron ore particles, but to apply sufficient force so that the feed material will tend to flow into the pocket sections of the rolls.

Suitable suppliers of briquetting machines are available throughout the world, but for the briquettes produced for the test work in the Example, a machine with screw feeder from Maschinenfabrik Köppern GmbH & Co. KG in Germany was used.

After the mixture passed through the rolls, a fully form compacted ‘green’ briquette cake was observed. By this it is meant that briquettes of a size above the volume of the individual pockets (but no larger than twice the volume thereof) were observed.

Often the briquettes will be joined together by a relatively thin skirt of feed material between them. This arises because of the objectives of ensuring that there is always an excess of mixture to fill the pockets and that the briquettes have been properly compacted.

It is not unusual to observe some variation in density of individual briquettes across the rolls due to feeding variations between rolls during compression of the mixture passing between them, i.e. feed to the edges of the rolls can be lower in practice.

As the briquettes pass downwardly from the rolls, it is usual for the briquettes to break up and size towards their set matrix sizes, with the scraps from such breakup passing through a selected screen/sieve 13 and then fed back to the screw feeder. Alternatively, such scrapped material could be returned to the shredder/mixer 3. Simple dropping of the briquettes after compaction will usually achieve breakup with scrap material being produced.

It is noted that it is important that the compression strength of the briquettes be sufficient so as to able to bear the static weight load and drag effects that arise through downstream processing in a direct reduction plant, which typically will be of a fixed bed configuration, although the use of a rotary kiln is not precluded.

For the test sample results provided in Table 1 of the Example, 12 individual briquettes were tested and averaged after the maximum and minimum results were excluded.

It is also noted that it is important that the briquettes be capable of withstanding handling and transportation without undue shattering. To mimic this performance requirement, 2 kg of briquettes, of each test sample, were dropped four times from a height of 2 m, with the fines sieved therefrom after the 2^{nd} and 4^{th} drops.

### Example—‘Green’ Briquettes in Accordance with an Embodiment of the Invention

The inventor directed extensive test work on:
(a) forming ‘green’ briquettes of lignocellulosic biomass material and iron ore fines with different lignocellulosic biomass materials and different ratios of lignocellulosic biomass materials and iron ore fines; and
(b) extensive test work on the ‘green’ briquettes.

The above description of FIG. 2 explains how the ‘green’ briquettes were formed and tested.

The photograph of FIG. 1 shows one such ‘green’ briquette.

Table 1 provides the compositions of a selection of the examples of compositions of ‘green’ briquettes of various lignocellulosic biomass material that were tested.

TABLE 1

| | | | | T.01 | T.02 | T.04 |
|---|---|---|---|---|---|---|
| Test Reference | T.10 | T.12 | T.20 | (2020) | (2020) | (2020) |
| Biomass | Wheat straw | Sorghum | Bagasse | Spruce | Spruce | Spruce/coal |
| Ore/Biomass (blend % by wt.) | 65/35 | 65/35 | 60/40 | 60/40 | 60/40 | 60/30/10 |
| Limestone % g wt. (with ref to ore) | 9.0 | 9.0 | 9.0 | 12.5 | 12.5 | 12.5 |
| Matrix size cm³ | 10 | 10 | 5 | 10 | 20 | 10 |
| Actual volume cm³ | 17.97 | 20.00 | 9.85 | 17.4 | 28.3 | 18.6 |
| Density g/cm³ | 1.48 | 1.43 | 1.43 | 1.64 | 1.5 | 1.80 |
| Strength (N) | 1814 | 1055 | 2084 | 877 | 657 | 1014 |
| Integral briquette remaining after | 85.68 | 83.21 | 83.38 | 84.3 | 67.5 | 79.0 |
| shatter test wt. %. 20 mm | | | | | | |

Table 1 also provides the properties (density and strength) and the performance (shatter test results) of the ‘green’ briquettes tested.

It is evident from Table 1 that suitable ‘green’ briquettes could be formed from a range of lignocellulosic biomass materials with different ratios of lignocellulosic biomass material and iron ore fines and, in the case of sample T.04, with coal as part of the mixture.

As noted above, the test work was conducted under the direction of the inventor. The experience of the inventor allows the inventor to extrapolate the results across the ranges of proportions of lignocellulosic and iron ore fines described in the specification.

Many modifications may be made to the embodiments described above without departing from the spirit and scope of the invention.

1. A compacted ‘green’ briquette that is suitable for a direct reduction process, the briquette being between 5 cm³ and 20 cm³ and including, prior to reduction in a direct reduction process, a composition of at least 30% lignocellulosic biomass material by dry weight and at least 55% iron ore fines by weight, a density of between 1.4 g/cm³ and 2.0 g/cm³, and a compaction strength of at least 500N.

2. A direct reduced iron briquette that is suitable for the production of iron and/or steel in a downstream ironmaking/steelmaking process including at least 85% iron by weight and at least 1% fixed carbon by weight, and having a volume of between 7.5 cm³ and 30 cm³, wherein the briquette has prior to reduction (i.e. as a ‘green’ briquette) a composition including at least 30% lignocellulosic biomass material by dry weight and at least 55% iron ore fines by weight.

3. A briquette according to claim 1 wherein the lignocellulosic biomass material is selected to flex around the iron ore fines during compaction of materials to form the ‘green’ briquette.

4. A briquette according to claim 1 wherein the ‘green’ briquette has a compaction strength of at least 850 N.

5. A briquette according to claim 1 wherein the lignocellulosic biomass material forms a majority of the surface area of the ‘green’ briquette prior to reduction.

6. A briquette according to claim 5 wherein the lignocellulosic biomass material includes dry tubular stalks of grasses.

7. A briquette according to claim 5 wherein the lignocellulosic biomass material includes wood saw dust.

8. A briquette according to claim 5 wherein the lignocellulosic biomass material includes dry tubular stalks of grasses and wood saw dust.

9. A briquette according to claim 2 wherein the briquette prior to reduction also contains non-volatile carbon material, said material not being lignocellulosic biomass material.

10. A briquette according to claim 2 wherein the briquette prior to reduction also contains no more than 5% non-volatile carbon material, said material not being lignocellulosic biomass material.

11. A briquette according to claim 9 wherein the amount of the non-volatile carbon material is selected so that the fixed carbon of the direct reduced iron briquette is at least 3% carbon by weight.

12. A briquette according to claim 9 wherein the amount of the non-volatile carbon material is selected so that the fixed carbon of the direct reduced iron briquette is at least 4% carbon by weight.

13. A briquette according to claim 9 wherein the non-volatile carbon material includes coal.

14. A briquette according to claim 9 wherein the non-volatile carbon material includes char, coke or carbon containing soot.

15. A briquette according to claim 1 in which a substantial amount of the iron ore fines is between 0.15 mm and 2.0 mm.

16. A briquette according to claim 2 including at least 1% by dry weight of a lime material for fluxing a slag from iron produced in downstream ironmaking/steelmaking processes.

17. A method of manufacturing the compacted ‘green’ briquette defined in claim 1 includes mixing together the lignocellulosic biomass material and the iron ore fines and compacting the mixture into the ‘green’ briquette.

18. A direct reduction process that includes reducing the ‘green’ briquette defined in claim 1 in a furnace and producing iron.
